(19) United States
(12) Patent Application Publication
(10) Pub. No.: US 2023/0284659 A1
(43) Pub. Date: Sep. 14, 2023

(54) Vitamin Enhanced Beverage

(71) Applicant: Brinda Aceituno, Miami Gardens, FL (US)

(72) Inventor: Brinda Aceituno, Miami Gardens, FL (US)

(21) Appl. No.: 17/692,400

(22) Filed: Mar. 11, 2022

(51) Int. Cl. A23L 2/60; A23L 2/66; A23L 2/04; A23L 2/06; A23L 33/10; A23L 33/15; A23L 33/16

(52) U.S. Cl. CPC A23L 2/60; A23L 2/66; A23L 2/04; A23L 2/06; A23L 33/10; A23L 33/15; A23L 33/16

(57) ABSTRACT

A low-calorie beverage of naturally-sourced ingredients to provide dietary supplements and hydration while providing a pleasing taste.

### CROSS-REFERENCES TO RELATED APPLICATIONS

Not Applicable.

### FIELD OF INVENTION

The present invention relates generally to a dietary supplement. More particularly, the present invention is related to a beverage to convey health benefits.

### BACKGROUND OF THE INVENTION

There exists a need for convenient, effective hydration as well as adequate nutrition.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention may comprise a low-calorie beverage of naturally-sourced ingredients to provide dietary supplements and hydration while providing a pleasing taste.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

Some embodiments may comprise water, natural flavoring derived from fruit juice, natural low-calorie and/or no-calorie sweeteners, and dietary supplement ingredients. Low-calorie and/or no-calorie sweeteners may include but are not limited to erythritol or similar sugar alcohol, stevia leaf extract, monk fruit extract or the like or combinations thereof. Some embodiments may further comprise naturally sourced acids, such as citric acid and malic acid, as flavor enhancements.

Dietary supplement ingredients may include but are not limited to vitamin A, Vitamin C, Vitamin E, Folic Acid, Thiamin, Riboflavin, Niacin, Vitamin B6, Vitamin B12, Biotin, Pantothenic Acid, Zinc, and Manganese, Eleutherococcus (Ginseng) extract, Guarana extract, Green tea extract or a combination thereof.

Some embodiments of the present invention may comprise the water, organic erythritol, strawberry juice and/or lemon juice, citric acid, malic acid, organic stevia leaf extract, and organic monk fruit extract. In some embodiments, the water may be derived via reverse osmosis.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A beverage comprising:
water;
sugar alcohol;
fruit juice;
citric acid;
malic acid;
stevia leaf extract; and
monk fruit extract.

2. The beverage of claim 1, wherein:
the water is sourced via reverse osmosis.

3. The beverage of claim 1, wherein:
the sugar alcohol is erythritol.

4. The beverage of claim 1, wherein:
the fruit juice is strawberry juice.

5. The beverage of claim 1, wherein:
the fruit juice is lemon juice.

6. The beverage of claim 1, further comprising:
at least one of vitamin A, Vitamin C, Vitamin E, Folic Acid, Thiamin, Riboflavin, Niacin, Vitamin B6, Vitamin B12, Biotin, Pantothenic Acid, Zinc, and Manganese, Eleutherococcus (Ginseng) extract, Guarana extract, and Green tea extract.
